(19) United States
(12) Patent Application Publication
(10) Pub. No.: US 2007/0124352 A1
(43) Pub. Date: May 31, 2007

(54) Efficiency implementation of the cordic algorithm fro complex phase rotation

(76) Inventor: Karl Raymond Wittig, New York, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/586,938

(22) PCT Filed: Jan. 25, 2005
(86) PCT No.: PCT/IB05/50295

§ 371 Date: Jul. 24, 2006

Related U.S. Application Data
(60) Provisional application No. 60/539,726, filed on Jan. 28, 2004.

(51) Int. Cl. G06F 15/00

(52) U.S. Cl. 708/200

(57) ABSTRACT

An improved implementation of the CORDIC algorithm that considers the n highest-order active bits in each stage of the CORDIC implementation resulting in increases in the precision of the final result by 2ⁿ. The rotational angle increment n−1 possible magnitudes that can be either positive or negative. The rotational angle increment is selected using the sign bit, along with the n−1 highest order active bits, of the rotation angle and an adjusted rotation angle is obtained by discarding the n highest-order active bits, and sign-extending the result using a negative sign when the lowest-order of these n bits equals the sign bit of present-stage rotation angle and a positive sign when they are different (this is equivalent to an exclusive NOR, or XNOR, operation on these two bits). Finally, the tangent is selected from 2ⁿ possible values (2ⁿ⁻¹ magnitudes, each with 2 signs), such that it corresponds to the present-stage rotation angle. The use of this method results in a CORDIC implementation for which each stage increases the precision of the final result by a factor of 2ⁿ, by considering n bits of the present-stage rotation angle. As a result, the number of stages needed, relative to the traditional implementation, is reduced by a factor of n.

This invention relates to improved techniques for implementing CORDIC (Coordinate Rotation Digital Computer) algorithms, and more particularly to improving the resource efficiency for hardware implementations of CORDIC algorithms that perform complex rotations.

A well-known method of digitally performing the rotation of a complex phasor over a desired angle uses the CORDIC (Coordinate Rotation Digital Computer) algorithm, an iterative procedure in which the desired rotation is successively approximated, and in which the numerical precision of the result increases by a factor of two each time an iteration that is performed. This algorithm can be implemented in software that is executed by a computer processor, or in a digital circuit that typically contains one stage per iteration. In systolic arrays having multiple small processors running at an instruction rate that is not a very large multiple of the sampling rate, the number of processors required once again corresponds to the number of iterations.

In one iteration, designated as k, of the traditional CORDIC algorithm, a phasor rotation from (xₖ₋₁, yₖ₋₁) to (xₖ, yₖ) is given by Equations 1a and 1b.
xₖ=xₖ₋ᵢ cos θₖ₋ᵢ sin θₖ Equation 1a
yₖ=yₖ₋ᵢ cos θₖ+xₖ₋₁ sin θₖ Equation 1b

The relationships expressed in Equations 1a and 1b can be expressed in a second form with the cosine term factored out of each expression within Equations 1a and 1b resulting in the relationship of Equations 2a and 2b so that the term within the parentheses requires only one trigonometric function and one multiplication.
xₖ=cos θₖ(xₖ₋ᵢ−yₖ₋ᵢ tan θₖ) Equation 2a
yₖ=cos θₖ(yₖ₋ᵢ+x_{K-i} tan θₖ) Equation 2b

For a given iteration of the algorithm, the rotation is performed using the value of the angle that corresponds to that iteration in either the positive or negative direction. It is important to note that a rotation is performed every iteration and that the absolute value of the rotation angle for a given iteration is always the same; only the sign, or direction, of the angle can vary within that iteration. The procedure is repeated for successively smaller iteration angle values until the desired rotation is converged upon to the specified degree of precision. The cosine factor for an iteration will have the same value due to the symmetry of the cosine function about zero and it becomes a constant term. As such, it can be combined with (i.e., multiplied by) the corresponding factor for each of the other iterations, so that only one multiplication is required at the end of the algorithm for each phasor component to reinstate this factor in the final result.

Convergence of the CORDIC algorithm is, conventionally, attained using rotation angles that successively decrease by a factor of two between a given iteration and the subsequent one. Although this conventional use of the CORDIC algorithm results in the most direct geometric convergence to the desired rotation angle, the CORDIC algorithm is often implemented using angles whose tangents are successive negative powers of two. This has the advantage of reducing the required multiplication by the tangent of the iteration angle to a simple right-shift operation, which is much more efficient to implement in hardware.

Prior art hardware implementations of the CORDIC algorithm, typically, require one stage to perform each iteration. The CORDIC algorithm is well known, and is very widely used in digital channel demodulator front-end applications, as well as numerous other applications that require the rotation of a complex number in the digital domain. Implementations of the CORDIC algorithm can commonly be found in channel demodulators that perform frequency down-conversions in the digital front end of the device.

In hardware and systolic array implementations of the CORDIC algorithm, the resources required assume the form of area on an integrated circuit device, and specifically consist of discrete logic or array processors, respectively. If a significant degree of numerical precision is desired, a substantial amount of resource will be needed to implement the algorithm.

In view of the foregoing discussion, it is readily apparent that there remains a need in the art for an implementation of the CORDIC algorithm that is more efficient and requires fewer resources.

The invention addresses the shortcoming in the prior art by providing an improved CORDIC algorithm that can perform complex rotations employing an iterative procedure in which the desired rotation is successively approximated, and in which the numerical precision of the result increases by a factor of two each time an iteration is performed. A conventional CORDIC algorithm implemented within hardware performs only one iteration for each stage. The present invention describes a method and apparatus for performing the equivalent of multiple iterations in a single stage, thereby reducing the number of stages required to achieve the same precision. A stage can be embodied within digital logic, a processor, an array of processors or within software.

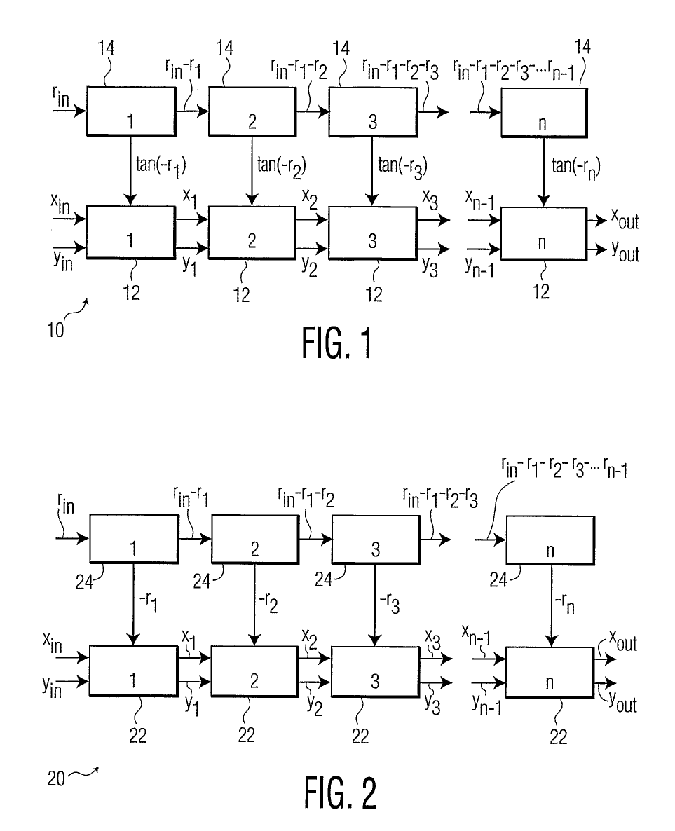

FIG. 1 is a diagram illustrating the functional blocks for a prior art implementation of the CORDIC algorithm;

FIG. 2 is a diagram illustrating the functional blocks the implementation of the CORDIC algorithm as envisioned by the invention; and

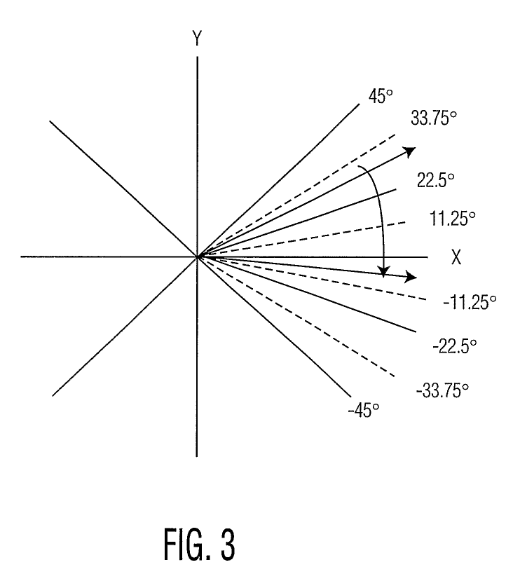

FIG. 3 is a phasor diagram illustrating incremental phasor rotation as envisioned by the invention.

This invention provides the performance of multiple iterations of the CORDIC algorithm within a single digital stage. Prior art implementations only result in performance of a single iteration in one stage, thereby requiring more digital resources. These prior art implementations for digitally performing the rotation of a complex phasor over a desired angle using a CORDIC algorithm in which the numerical precision of the result increases by a factor of two. Additionally these prior art methods can be performed in digital circuits that typically comprise one stage per iteration. Systolic arrays employing multiple small processors running at an instruction rate that is not a very large multiple of the sampling rate can be adapted to run the CORDIC algorithm, the number of processors required once again corresponds to the number of iterations.

The invention can be implemented within an integrated circuit that provides custom-designed discrete logic, in a systolic or other configurable processor array in which each processor comprises a stage that can perform more than one iteration of the CORDIC algorithm. In the hardware and systolic array implementations of this algorithm, the resources required assume the form of area on an integrated circuit device, discrete logic or array processors.

The present invention describes an adaptation of the CORDIC algorithm that lends itself to hardware or systolic array implementations, and reduces the resources required to attain a specified degree of precision by a factor of two or greater.

A multi-stage hardware implementation of an n-iteration CORDIC algorithm is shown in FIG. 1. Conventionally, convergence of the CORDIC algorithm is attained using rotation angles that successively decrease by a factor of two. As shown in FIG. 1, the compares 14 each have an input that receives an angle value (rᵢₙ, rᵢₙ−r₁, rᵢₙ−r₁−r₂, rᵢₙ−r₁−r₂−r₃ . . . rᵢₙ−r₁−r₂−r₃−rₙ₋₁) that represents the convergence of the CORDIC algorithm towards the desired angle. Each of compares 14 outputs an angle value that is reduced in value as previously discussed to the next compare 14. Each of compares 14 also outputs a tangent of the angle used within that respective compare to successively reduce the current angle. These tangents are used as values for rotations 12 as described in equation 2b and illustrated in FIG. 1. The CORDIC algorithm is often implemented using angles whose tangents are successive negative powers of two, such as represented by the expression of Equations 3a and 3b below, which simplifies the process to a right-shift operation, which is much more efficient to implement in hardware. In the hardware implementation 10 illustrated in FIG. 1, one stage is required for each of the iterations performed as indicated by the kth iteration in the above Equations 3a and 3b.
tan(−Rₖ)=−2^{-k} (traditionally) Equation 3a
−Rₖ=−2^{-k} (alternatively) Equation 3b
−Rₖ=−2^{-jk}; j>1 (as envisioned by the invention) Equation 3c

The invention envisions that a reduction in the number of stages required for a given precision, or, conversely a mechanism for improving the precision provided by each stage would greatly enhance the above discussed hardware implementation. The invention envisions using the angles themselves rather than the tangents of the angles for convergence of the CORDIC algorithm in a manner expressed by Equation 3c. As shown in FIG. 2, the hardware implementation 20 of the CORDIC algorithm has one stage for each of the iterations. However in FIG. 2 the rotational stages 22 actually perform rotations by the values of the angles —R₁, −R₂, −R₃ . . . −Rₙ whose angles are negative power of two instead of rotating by the angles whose tangents of those angles as previously discussed for the prior art implementation of FIG. 1. It should be noted that the angles —R₁, −R₂, −R₃ . . . −Rₙ in FIG. 2 whose angles are used for rotational values are not the same angles —r₁, −r₂, −r₃ . . . −rₙ whose tangents are used for rotational values in FIG. 1.

The most preferred embodiments of present invention employ a systolic processor array, but it is also specifically envisioned that discrete logic implementations can be used to perform improved CORDIC algorithm. The most fundamental premise of the invention is that the precision of the rotation angle is increased each iteration by a factor of four instead of by a factor of two as in prior art implementations of the CORDIC algorithm. It is equally envisioned that even still higher powers of two can be implemented and this exponential factor is designated by the term j in Equation 3c above, with j>1.

The prior art employs technique for rotating using iteration angles whose tangents are negative powers of two. The present invention, instead, uses iteration angles that themselves are negative powers of two. The technique employed by the present invention requires the use of a multiplier in each stage, but results in a reduction in the number of stages required making the technique of the invention a worthwhile tradeoff. Moreover, in the hardware implementations using a systolic array of processors that contain multipliers, the multiplying stage becomes an insignificant consideration.

The invention provides an advantage by imposing the negative-power-of-two on the angles instead of the tangents of the angles. Thus, the comparisons required by the algorithm of the invention can be performed very easily, which in turn allows the equivalent of multiple iterations as performed by prior art implementations to be performed in one stage.

As a further illustration, consider the implementation of the invention wherein each stage increases the precision by a factor of four. Such as implementation is illustrated, in FIG. 3 and described below for the specific case of a rotation of up to 45 degrees in either direction. A rotation of up to 45 degrees corresponds to the largest incremental rotation that would be performed by the preferred embodiment of the algorithm, because the symmetries of the trigonometric functions with respect to the four quadrants of the rotation plane reduce an arbitrary rotation to the case of 45 degrees. Subsequent stages, corresponding to subsequent CORDIC algorithm iterations, would perform correspondingly smaller rotations.

FIG. 3 is a rotational diagram that illustrates the concept of the invention. The x-axis represents the desired rotation that is achieved by successive rotations of the CORDIC algorithm of the invention. The following description describes a preferred embodiment of the invention that employs a power of 2 increment for each rotation. It is important to note that 360 degrees corresponds to a power of 2, as does 180 degrees, and 90 degrees. Accordingly, the invention views the entire 360 degrees possible for a phasor as four separate quadrants of 90 degrees. Therefore, as viewed from the boundaries of each quadrant, only a maximum of 45 degrees rotation is required to reach any potential phasor. The application of the CORDIC algorithm as envisioned by the invention rotates by making two determinations. First, the rotational angle is determined to be either is positive or negative. This determination is preferably made by a comparison that determines the sign of the rotation that is to be made by compares 24. Second, compares 24 make a determination of the absolute value for the rotational angle that is to be made, which in the case of the first rotation is preferably made by a comparison to check if the absolute value is greater or less than 22.5 degrees. The value of 22.5 degrees is used in the first rotation because it is half the maximum value of 45 degrees. The determination of the absolute value for the first rotation of the rotational angle shown in FIG. 3 determines the magnitude of the rotational angle from two possible values of 33.75 and 11.25 degrees. The example in FIG. 3 illustrates a rotational angle that is greater than 22.5 degrees, but less than 33.75 degrees. As shown in FIG. 3, the example, the phasor is rotated by −33.75 degrees, which passes the ultimate rotational target represented by the x-axis.

Continuing with the example illustrated in FIG. 3, since the result of the first rotation described above passed the ultimate rotational target represented by the x-axis, the effect of the first rotation is that the next rotation must proceed in the opposite direction. Therefore, the next rotation (the second rotation) will be in the opposite direction of the first rotation as determined by the comparison of the first determinations as discussed above. The comparison of the first determination results in the determination that the next rotation will be positive. The comparison performed by the second determination will employ values that are half the values employed to determine the absolute value of the rotation in the first rotation, and the phasor components are adjusted using their respective tangents according to Equations 1a and 1b. The value of 11.25 degrees is used in the second rotation because it is half the value of 22.5 degrees used in the previous rotation. The determination of the absolute value in the second rotation of the rotational angle shown in FIG. 3 determines the magnitude of the rotational angle from two possible values of 16.875 and 5.625 degrees. Proceeding in this manner for each successive stage allows the inventive implementation of the CORDIC algorithm to converge on the desired rotation much quicker than conventional implementations of the CORDIC algorithm. It will be readily apparent to those skilled in the art that the foregoing discussed rotational stages are each equivalent to two CORDIC stages in conventional implementations of the CORDIC algorithm.

An important observation is that for an angle representation in which 360 degrees corresponds to a power of 2, the required comparisons discussed above can be made by simply examining the two highest-order active binary digits, or bits, of the present-stage angle, along with its sign bit, without performing an actual arithmetic comparison. Furthermore, the adjusted rotation angle for the subsequent stage now consists entirely of the lower-order bits (relative to the two present-stage bits), with at most a negation in the case of a sign change (relative to the present-stage angle). In particular, the higher-order of these two bits determines the magnitude (the smaller rotation if it is the same as the sign bit, the larger if it is the inverse) of the present-stage rotation angle, and the sign bit determines its sign (the latter is just the inverse of the former). The adjusted rotation angle is obtained by discarding the two most significant bits from the present-stage rotation angle, and negating the result if the lower-order of the two bits equals the sign bit. Finally, the tangent is selected from four possible values (two magnitudes, each with two signs) such that it corresponds to the present-stage rotation angle. The use of this method results in a CORDIC implementation for which each stage increases the precision of the final result by a factor of 4, or 2², by considering 2 bits of the present-stage rotation angle. As a result, only half as many stages are needed in the implementation for the inventive CORDIC algorithm previously described compared to convention implementations of the CORDIC algorithm.

Accordingly, the rotational angle can be represented as a first comparison that determines the direction by identifying the sign of the rotation, and a second comparison that determines the absolute value of the magnitude from the two possible values. Alternatively, the rotation can be regarded as a choice of one out of four possible values, two positive and two negative. Using either approach, the rotational angle for the subsequent stage is adjusted by the determined value in the determined direction.

The method and apparatus of the invention can be further generalized by considering 3 or more highest-order active bits of the present stage rotation angle. In particular, consider the n highest-order active bits, in which case each stage of the CORDIC implementation now increases the precision of the final result by 2ⁿ. The present-stage rotation angle can now assume n−1 possible magnitudes, in each case either positive or negative. This angle is selected using the sign bit, along with the n−1 highest order active bits, of the present-stage rotation angle; the adjusted rotation angle is obtained by discarding the n highest-order active bits, and sign-extending the result using a negative sign when the lowest-order of these n bits equals the sign bit of present-stage rotation angle and a positive sign when they are different (this is equivalent to an exclusive NOR, or XNOR, operation on these two bits). Finally, the tangent is selected from 2ⁿ possible values (2ⁿ⁻¹ magnitudes, each with 2 signs), such that it corresponds to the present-stage rotation angle. The use of this method results in a CORDIC implementation for which each stage increases the precision of the final result by a factor of 2ⁿ, by considering n bits of the present-stage rotation angle. As a result, the number of stages needed, relative to the traditional implementation, is reduced by a factor of n.

The methodology is illustrated by the representation:
ss . . . sbₙbₙ₋₁ . . . b₁xx . . . x;

wherein the s digits represent the sign extension for the current stage (and as such are all identical), the b digits represent the n highest-order active bits for this stage, and the x digits represent the lower-order bits (each takes on a value independently of the others).

The rotation angle of the stage, along with its tangent, is selected using the n digits:
sbₙbₙ₋₁ . . . b₂.

The sign of the adjusted rotation angle for the subsequent stage is given by:
s′=s XNOR b₁

The latter sign bit s′ is used to perform a sign extension on the low-order x bits that results in the correct word length (i.e., total number of bits), so that the adjusted rotation angle is just:
s′ s′ . . . s′ xx . . . x

In yet another variation of this method, the traditional scheme of using angles whose tangents are negative powers of two can be employed, particularly for smaller angles that are close in value to their tangents (this is a well-known trigonometric approximation for small angles). In this case, however, the angles themselves do not have the simple binary representation that permits comparisons to be performed by examining only the n uppermost active bits. Consequently, n full arithmetic comparisons must be performed. This presents a trade-off between the more complicated comparison and the simplified multiplication that are needed in this case.

An important application of this invention is in the front-end portion of digital signal processing systems that perform channel demodulation. In particular, it lends itself to a very efficient implementation on a systolic array comprising a multiplicity of small processors. In this case, it can be implemented using a small number of such processors.

1. A method for efficiently implementing the CORDIC complex phasor rotation comprising the steps of:
implementing a CORDIC algorithm using successive stages;
computing an incremental angle of rotation based on an examination of a plurality of highest-order active bits within a binary representation of a complete rotation angle; and
performing an incremental rotation based the incremental angle of rotation.

2. The method of claim 1 further comprising:
removing the highest order-bits from the complete rotation angle to create a remaining rotation angle and computing a next incremental angle based upon examination of another examination of highest order bits for the remaining rotation angle;
performing a another incremental rotation based on the next incremental step; and
repeating the removing and performing steps until the complete rotation angle is achieved.

3. The method of claim 1 wherein the step of computing further comprises two or more arithmetic comparisons of the complete rotation angle.

4. The method of claim 3 wherein the step of performing the incremental rotation further comprises a step of multiplying the tangents of the angles which were selected using only the highest order bits.

5. The method of claim 1 wherein the steps are performed within one or more digital logic devices.

6. The method of claim 5 wherein the digital logic devices further comprise a systolic processor array.

7. The method of claim 2 wherein the step of computing further comprises a comparison of n highest-order active bits within the binary representation of the complete rotation angle with a plurality of possible magnitudes for the incremental angle of rotation and selecting one of the magnitudes which can be either positive or negative.

8. A method for efficiently implementing the CORDIC complex phasor rotation comprising the steps of:
computing an incremental angle of rotation based on an examination of a plurality of highest-order active bits within a binary representation of a complete rotation angle;
performing an incremental rotation based the incremental angle of rotation;
discarding the highest order bits from the complete rotation angle to obtain a resulting rotation angle comprising the lowest order its of the complete rotation angle;
sign extending the resulting rotation angle.

9. The method for efficiently implementing the CORDIC complex phasor rotation of claim 8 wherein the step of computing further comprises comparing the highest order bits with a set to determine a relative value for the incremental angle.

10. The method for efficiently implementing the CORDIC complex phasor rotation of claim 8 wherein the step of computing further comprises computing a present-stage rotation angle that is a difference between the complete rotation angle and the incremental angle of rotation.

11. The method for efficiently implementing the CORDIC complex phasor rotation of claim 10 wherein the step of sign extending further comprises using a negative sign when the lowest-order bits equals the sign bit of present-stage rotation angle and a positive sign when they are different

12. A device for implementing CORDIC complex phasor rotations comprising:
a plurality of compare stages (24) that receive an input angle and provide a comparison between the input angle and a rotational angle, each compare stage (24) outputting a difference between the input angle and the rotational angle and also providing an output for the rotational angle; and
a plurality of rotation stages (22) that receive the rotational angles from the compares (24) and implement a phasor rotation based on an examination of a plurality of highest order bits within a binary representation of the input angle.

13. The device of claim 12 wherein the compare stages (24) compute the rotational angle as a power of two.

14. The device of claim 13 wherein the rotation stages (22) contain a multiplier that multiplies tangents of angles which angles were selected using only the highest order bits of the angles.

15. The device of claim 12 wherein the device is contained within one or more digital logic devices.

16. The device of claim 12 wherein the device is implemented within a systolic processor array.

17. The device of claim 12 wherein the compare stages (24) provide a comparison of n highest-order active bits within the binary representation of the input angle with a plurality of possible magnitudes for the rotational angle and selects one of the magnitudes which can be either positive or negative.
